(19) United States
(12) Patent Application Publication
(10) Pub. No.: US 2026/0113067 A1
(43) Pub. Date: Apr. 23, 2026

(54) MAGNETIC FIXING ASSEMBLY OF SCREEN PROTECTOR

(71) Applicant: VicRound Limited Company, Taipei (TW)

(72) Inventor: Shui-Chin CHEN, Taipei (TW)

(21) Appl. No.: 18/954,810

(22) Filed: Nov. 21, 2024

(30) Foreign Application Priority Data
Oct. 23, 2024 (TW) 113211481

(51) Int. Cl. H04B 1/3888; H04M 1/02

(52) U.S. Cl. CPC H04B 1/3888; H04M 1/0266

(57) ABSTRACT

A magnetic fixing assembly of a screen protector is configured to detachably fix a screen protector on a surface of a display screen and has a fixing unit and a magnetic unit. The fixing unit has a first adhesive sheet, such that the fixing unit can be attached to a border of the display screen. The magnetic unit has a sheet body, a second adhesive sheet, an anti-bending sheet, and at least one magnetic part. The anti-bending sheet and the magnetic part are mounted on the second adhesive sheet, such that the magnetic unit and the fixing unit are magnetically attracted to each other. The screen protector can be attached to the magnetic unit by the second adhesive sheet. Therefore, the screen protector can be detached from the display screen.

### BACKGROUND OF THE INVENTION

### 1. Field of the Invention

The present invention relates to a fixing assembly of a screen protector, especially to a magnetic fixing assembly that can detachably fix a screen protector on a surface of a display screen.

### 2. Description of the Prior Arts

As technology advances day by day, desktop computers, notebook computers, smart phones, etc. have become necessary electronic products in life. Depending on different purposes, the user can attach screen protectors with different functions to the surface of the display screen of electronic products. For example, the user can purchase a screen protector with anti-scratch and anti-impact functions to prevent the display screen from being cracked or scratched by impact. The user can purchase a screen protector with anti-blue light function to protect their eyes. The user can purchase a screen protector with anti-peep function to limit the angle at which the display screen can be seen, thus protecting the user's privacy.

The conventional screen protectors are mostly installed on the surface of the display screen by being directly adhered or frame-fitted. If the screen protector is installed on the surface of the display screen by adhesive, the user cannot remove the screen protector or replace it with a screen protector with different functions at any time. In addition, when the adhered screen protector is removed from the surface of the display screen, adhesive residue will be left on the surface of the display screen, or the structure of the screen protector will be damaged. If the screen protector is installed on the surface of the display screen with a frame, the frame may be worn during repeated installation and removal of the screen protector, thereby affecting the stability of the screen protector mounted on the surface of the display screen.

To overcome the shortcomings, the present invention provides a magnetic fixing assembly for a screen protector to mitigate or obviate the aforementioned problems.

### SUMMARY OF THE INVENTION

The main objective of the present invention is to provide a magnetic fixing assembly for a screen protector that is configured to detachably fix a screen protector on a surface of a display screen.

The magnetic fixing assembly for a screen protector comprises a fixing unit and a magnetic unit. The material of the fixing unit includes metal, and the fixing unit comprises a bottom surface, a top surface, and a first adhesive sheet. The bottom surface and the top surface are two opposite surfaces of the fixing unit. The first adhesive sheet is mounted on the bottom surface.

The magnetic unit is detachably mounted on the fixing unit and is magnetically attached to the fixing unit. The magnetic unit comprises a sheet body, a second adhesive sheet, at least one magnetic part, and an anti-bending sheet.

The sheet body is detachably mounted on the fixing unit and is bendable. The second adhesive sheet is mounted on one side of the sheet body and comprises a second adhesive layer and a second release film. The second adhesive layer is mounted on the sheet body, and the second release film is detachably attached to the second adhesive layer.

The at least one magnetic part is mounted between the second adhesive layer and the second release film of the second adhesive sheet. The anti-bending sheet is mounted between the second adhesive layer and the second release film of the second adhesive sheet and is adjacent to the at least one magnetic part. An area of the anti-bending sheet is smaller than an area of the sheet body, and the area of the anti-bending sheet is smaller than an area of the second adhesive sheet. The anti-bending sheet is capable of preventing the at least one magnetic part from being bent.

The advantage of the present invention is that the screen protector is attached to the magnetic unit, the fixing unit is attached to the border of the display screen, and the magnetic unit and the fixing unit are magnetically attracted to each other. Therefore, the user can remove the screen protector from the display screen or can replace the original screen protector with another screen protector with different functions at any time. In addition, installing the screen protector through the magnetic force prevents the magnetic unit and the fixing unit from being worn during disassembly and assembly, thereby maintaining the stability of the screen protector on the surface of the display screen, and extending the life of the magnetic fixing assembly of screen protector.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a magnetic unit in accordance with the present invention, shown disassembled;

FIG. 2 is an exploded view of the magnetic unit in FIG. 1, shown disassembled;

FIG. 3 is a top view of the magnetic unit in FIG. 1, shown disassembled;

FIG. 4 is a perspective view of the assembly process of the magnetic unit in FIG. 1;

FIG. 5 is a perspective view of the magnetic unit in FIG. 1, shown assembled;

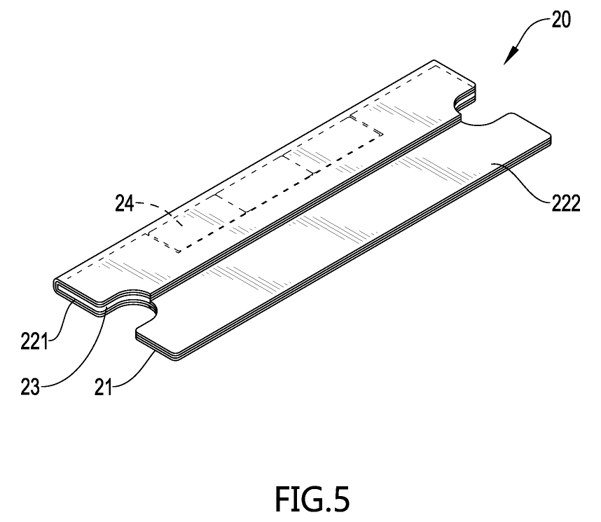

FIG. 6 is a perspective view of a magnetic fixing assembly of a screen protector in accordance with the present invention;

FIG. 7 is another perspective view of the magnetic fixing assembly of a screen protector in FIG. 6;

FIG. 8 is a perspective view of the magnetic fixing assembly for a screen protector in FIG. 6, shown in use; and

FIG. 9 is an enlarged sectional view of the magnetic fixing assembly for a screen protector in FIG. 6, shown in use.

### DETAILED DESCRIPTION OF THE PREFERRED EMBODIMENTS

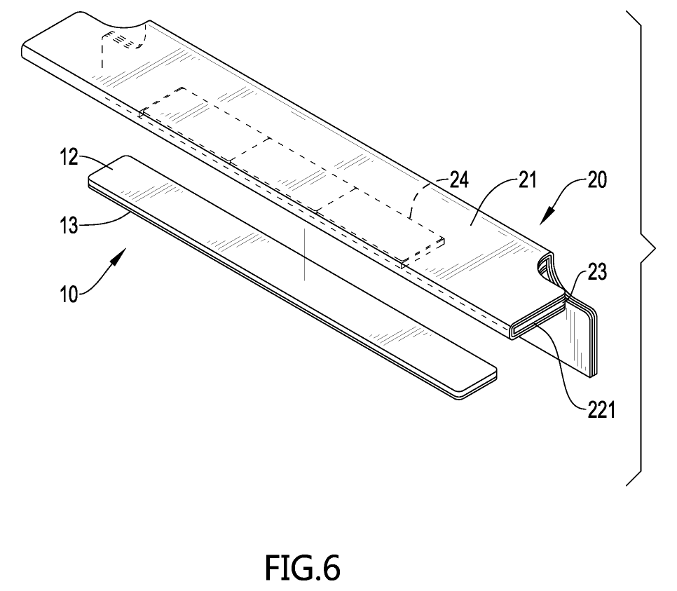

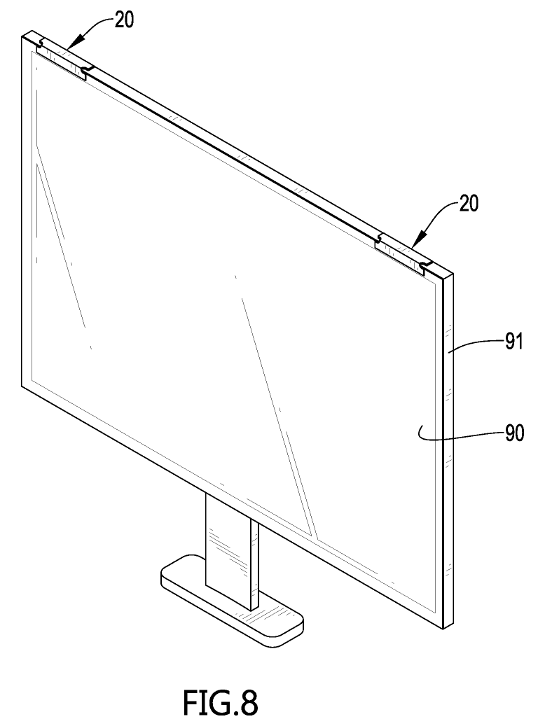

With reference to FIG. 6 and FIG. 8, a magnetic fixing assembly of a screen protector in accordance with the present invention is configured to detachably fix a screen protector 90 on a surface of a display screen 91. The magnetic fixing assembly of the screen protector comprises a fixing unit 10 and a magnetic unit 20.

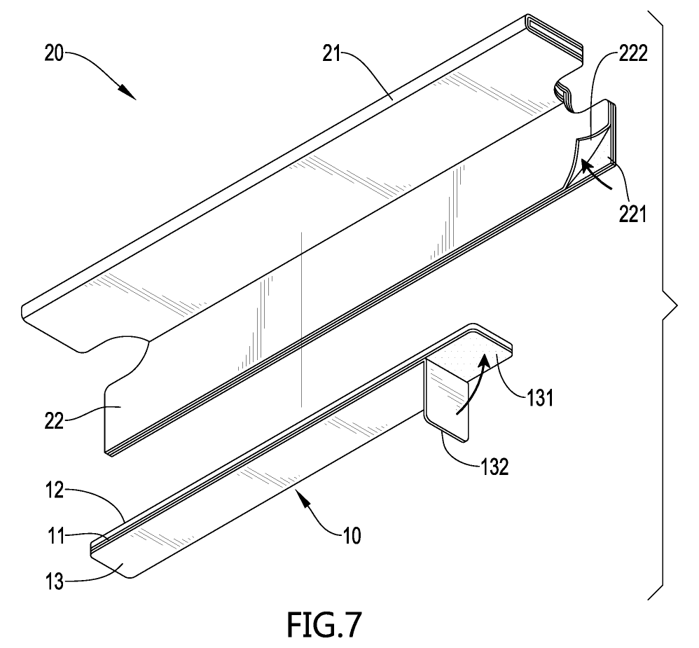

With reference to FIG. 7 to FIG. 9, the fixing unit 10 is configured to be attached to a border of the display screen 91 and comprises a bottom surface 11, a top surface 12, and a first adhesive sheet 13. The bottom surface 11 and the top surface 12 are two opposite surfaces of the fixing unit 10, and the bottom surface 11 faces the border of the display screen 91. The first adhesive sheet 13 is mounted on the bottom surface 11 of the fixing unit 10 and comprises a first adhesive layer 131 and a first release film 132. The first adhesive layer 131 is mounted on the bottom surface 11 of the fixing unit 10, and the first release film 132 is detachably attached to the first adhesive layer 131. When the first release film 132 and the first adhesive layer 131 are separated, the fixing unit 10 can be attached to the border of the display screen 91 through the first adhesive layer 131 of the first adhesive sheet 13.

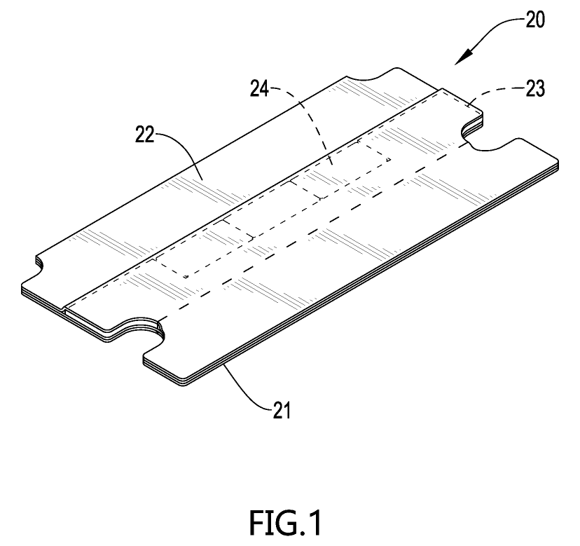

With reference to FIG. 1 to FIG. 3, FIG. 6, and FIG. 8, the magnetic unit 20 is detachably mounted on the fixing unit 10 and magnetically attached to the fixing unit 10. The magnetic unit 20 comprises a sheet body 21, a second adhesive sheet 22, an anti-bending sheet 23, and at least one magnetic part 24. The sheet body 21 is detachably mounted on the fixing unit 10 and comprises a first segment 211, a second segment 212 and a third segment 213. The first segment 211, the second segment 212, and the third segment 213 of the sheet body 21 are arranged in sequence. The sheet body 21 can be bent between the first segment 211 and the second segment 212 and can be bent between the second segment 212 and the third segment 213.

The second adhesive sheet 22 is mounted on one side of the sheet body 21 and comprises a second adhesive layer 221, a second release film 222, a first part, and a second part. The second adhesive layer 221 is mounted on the sheet body 21, and the second release film 222 is detachably attached to the second adhesive layer 221. The first part and the second part divide the second adhesive sheet 22 into two parts, that is, the second adhesive layer 221 and the second release film 222 are also divided into two parts respectively. The first part of the second adhesive sheet 22 is corresponding to the first segment 211 and the second segment 212 of the sheet body 21 in location, and the second part of the second adhesive sheet 22 is corresponding to the third segment 213 of the sheet body 21 in location. In this embodiment, the first part and the second part of the second release film 222 are combined in a half-cut form and can be separated from each other, but it is not limited thereto.

When the second release film 222 and the second adhesive layer 221 located on the first part are separated, the sheet body 21 can be bent between the first segment 211 and the second segment 212, and the first segment 211 and the second segment 212 are attached to each other. When the second release film 222 and the second adhesive layer 221 located on the second part are separated, the screen protector 90 can be attached to the third segment 213 of the second part sheet body 21 by the second adhesive layer 221.

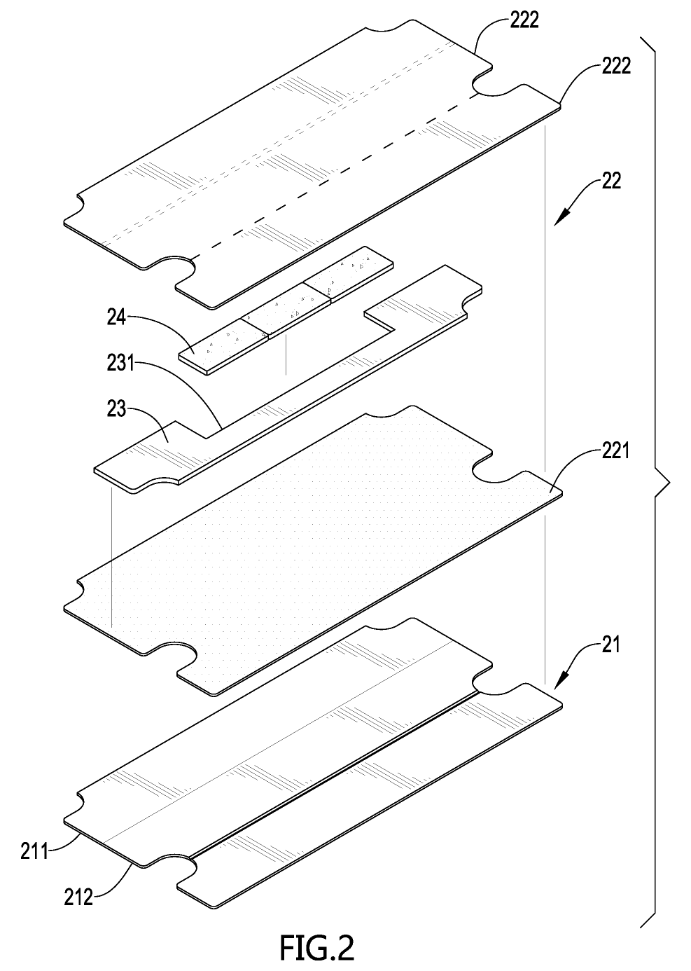

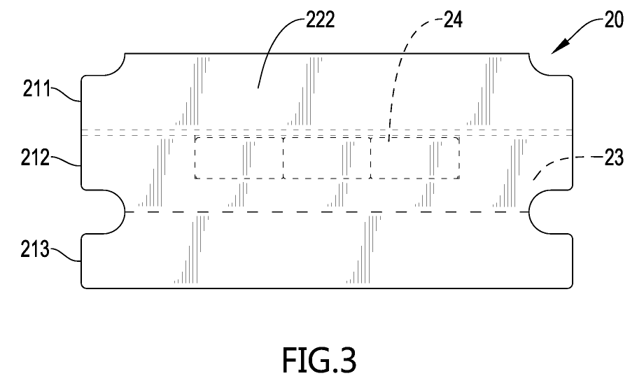

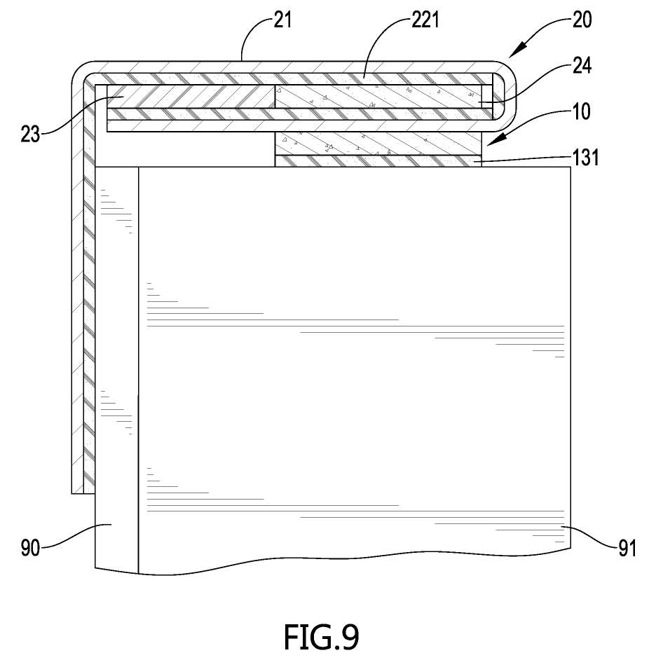

With reference to FIG. 2, FIG. 3, and FIG. 9, the anti-bending sheet 23 and the magnetic part 24 are mounted between the second adhesive layer 221 and the second release film 222 of the second adhesive sheet 22. An area of the anti-bending sheet 23 and the magnetic part 24 is smaller than an area of the sheet body 21 and is smaller than an area of the second adhesive sheet 22. In this embodiment, the anti-bending sheet 23 and the magnetic part 24 are correspondingly mounted on the second segment 212 of the sheet body 21, and the area of the anti-bending sheet 23 and the magnetic part 24 is the same as an area of the second segment 212 of the sheet body 21, but it is not limited thereto. The anti-bending sheet 23 comprises a cavity 231, and the at least one magnetic part 24 includes three said magnetic parts 24. The magnetic parts 24 are mounted in the cavity 231 of the anti-bending sheet 23, such that the anti-bending sheet 23 can prevent the magnetic parts 24 from being bent. In this embodiment, the cavity 231 of the anti-bending sheet 23 is located on an edge of the anti-bending sheet 23. In another embodiment, the cavity 231 of the anti-bending sheet 23 can be at least one hole, making the anti-bending sheet 23 around the at least one magnetic part 24.

With reference to FIG. 6, in this embodiment, the fixing unit 10 is a metal strip, and the magnetic part 24 is a magnet and is mounted on the magnetic unit 20. Therefore, the magnetic unit 20 can be magnetically attracted to the fixing unit 10. In another embodiment, the fixing unit 10 can be a magnet, and the material of the magnetic unit 20 includes metal, or both the fixing unit 10 and the magnetic unit 20 have magnetism, as long as the magnetic unit 20 can be magnetically attracted to the fixing unit 10.

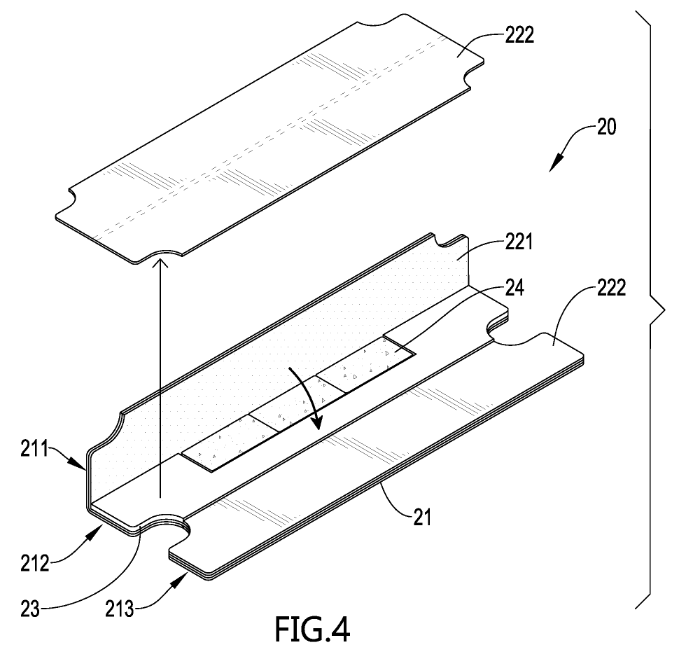

With reference to FIG. 4, FIG. 7 to FIG. 9, the user first removes the second release film 222 of the first part of the second adhesive sheet 22 and bends the sheet body 21. Through the second adhesive layer 221 of the first part, the first segment 211 of the sheet body 21 is attached to the anti-bending sheet 23 and the magnetic parts 24 located on the second segment 212. Then the second release film 222 of the second part of the second adhesive sheet 22 is removed, and the screen protector 90 is attached to the third segment 213 of the sheet body 21 of the magnetic unit 20 by the second adhesive layer 221 of the second part. Then the magnetic unit 20 is magnetically attracted to the fixing unit 10. The user finally removes the first release film 132 of the first adhesive sheet 13, and the fixing unit 10 is attached to the border of the display screen 91 by the first adhesive layer 131.

The advantage of the present invention is that the screen protector 90 is attached to the magnetic unit 20, the fixing unit 10 is attached to the border of the display screen 91, and the magnetic unit 20 and the fixing unit 10 are magnetically attracted to each other. Therefore, the user can remove the screen protector 90 from the display screen 91 or can replace the original screen protector 90 with another screen protector 90 with different functions at any time. In addition, installing the screen protector 90 through the magnetic force prevents the magnetic unit 20 and the fixing unit 10 from being worn during disassembly and assembly, thereby maintaining the stability of the screen protector 90 on the surface of the display screen 91, and extending the life of the magnetic fixing assembly of the screen protector.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A magnetic fixing assembly for a screen protector comprising:
a fixing unit comprising:
a bottom surface;
a top surface opposite the bottom surface;
a first adhesive sheet mounted on the bottom surface;
a magnetic unit detachably mounted on the fixing unit and magnetically attached to the fixing unit; the magnetic unit comprising:
a sheet body detachably mounted on the fixing unit and being bendable;
a second adhesive sheet mounted on one side of the sheet body; the second adhesive sheet comprising:
a second adhesive layer mounted on the sheet body;
a second release film detachably attached to the second adhesive layer;
at least one magnetic part mounted between the second adhesive layer and the second release film of the second adhesive sheet;
an anti-bending sheet mounted between the second adhesive layer and the second release film of the second adhesive sheet and adjacent to the at least one magnetic part; an area of the anti-bending sheet being smaller than an area of the sheet body, and the area of the anti-bending sheet being smaller than an area of the second adhesive sheet; the anti-bending sheet being capable of preventing the at least one magnetic part from being bent.

2. The magnetic fixing assembly for a screen protector as claimed in claim 1, wherein the sheet body comprises a first segment, a second segment, and a third segment; the first segment, the second segment, and the third segment are arranged in sequence, and the at least one magnetic part and the anti-bending sheet are mounted on the second segment of the sheet body.

3. The magnetic fixing assembly for a screen protector as claimed in claim 2, wherein the sheet body is bendable between the first segment and the second segment, and the sheet body is bendable between the second segment and the third segment.

4. The magnetic fixing assembly for a screen protector as claimed in claim 2, wherein the second adhesive sheet comprises a first part and a second part; the first part is corresponding to the first segment and the second segment of the sheet body in location, and the second part is corresponding to the third segment of the sheet body in location.

5. The magnetic fixing assembly for a screen protector as claimed in claim 3, wherein the second adhesive sheet comprises a first part and a second part; the first part is corresponding to the first segment and the second segment of the sheet body in location, and the second part is corresponding to the third segment of the sheet body in location.

6. The magnetic fixing assembly for a screen protector as claimed in claim 1, wherein the anti-bending sheet comprises a cavity; the at least one magnetic part is mounted in the cavity of the anti-bending sheet.

7. The magnetic fixing assembly for a screen protector as claimed in claim 5, wherein the anti-bending sheet comprises a cavity; the at least one magnetic part is mounted in the cavity of the anti-bending sheet.

8. The magnetic fixing assembly for a screen protector as claimed in claim 1, wherein the at least one magnetic part includes three said magnetic parts.

9. The magnetic fixing assembly for a screen protector as claimed in claim 7, wherein the at least one magnetic part includes three said magnetic parts.

10. The magnetic fixing assembly for a screen protector as claimed in claim 1, wherein the first adhesive sheet comprises:
a first adhesive layer mounted on the bottom surface of the fixing unit;
a first release film detachably attached to the first adhesive layer.

11. The magnetic fixing assembly for a screen protector as claimed in claim 9, wherein the first adhesive sheet comprises:
a first adhesive layer mounted on the bottom surface of the fixing unit;
a first release film detachably attached to the first adhesive layer.
